(19) United States
(12) Patent Application Publication
(10) Pub. No.: US 2023/0289385 A1
(43) Pub. Date: Sep. 14, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Yosuke MORIUCHI, Toyota-shi (JP); Ryo YAMADA, Nagakute-shi (JP); Ayana ICHIKAWA, Nagoya-shi (JP); Takashi MIZUNO, Toyota-shi (JP); Kimi SUGAWARA, Tokyo (JP); Shigeki MATSUMOTO, Nagoya-shi (JP)

(21) Appl. No.: 18/149,703

(22) Filed: Jan. 4, 2023

(30) Foreign Application Priority Data
Mar. 10, 2022 (JP) 2022-037286

(51) Int. Cl. G06F 16/787; H04N 7/18; H04N 5/77; G06F 16/71

(52) U.S. Cl. CPC G06F 16/787; G06F 16/71; H04N 5/772; H04N 7/183

(57) ABSTRACT

An information processing device includes a storage unit and a controller. The storage unit is configured to store video information that is information on a video captured by an in-vehicle camera and uploaded by a first user. The controller is configured to execute accepting designation of a point or a section from a second user, and extracting a first video including the designated point or section from among a plurality of the uploaded videos.

### CROSS-REFERENCE TO RELATED APPLICATION

This application claims priority to Japanese Patent Application No. 2022-037286 filed on Mar. 10, 2022, incorporated herein by reference in its entirety.

### BACKGROUND

### 1. Technical Field

The present disclosure relates to a video sharing service.

### 2. Description of Related Art

A technique for sharing an in-vehicle video captured by a drive recorder among a plurality of users. In this regard, Japanese Unexamined Patent Application Publication No. 2019-106097 (JP 2019-106097 A) discloses a system that shares a video captured by a first vehicle with a user of a second vehicle.

### SUMMARY

The present disclosure is to improve the convenience for a user of a vehicle.

A first aspect of the present disclosure relates to an information processing device including a storage unit and a controller. The storage unit is configured to store video information that is information on a video captured by an in-vehicle camera and uploaded by a first user. The controller is configured to execute accepting designation of a point or a section from a second user, and extracting a first video including the designated point or section from among a plurality of the uploaded videos.

In addition, a second aspect of the present disclosure relates to an information processing method including a step of acquiring video information that is information on a video captured by an in-vehicle camera and uploaded by a first user. The information processing method includes a step of accepting designation of a point or a section from a second user. The information processing method includes a step of extracting a first video including the designated point or section from among a plurality of the uploaded videos.

In addition, a third aspect of the present disclosure relates to a storage medium storing a program causing a computer to execute a step of acquiring video information that is information on a video captured by an in-vehicle camera and uploaded by a first user. The computer executes a step of accepting designation of a point or a section from a second user. The computer executes a step of extracting a first video including the designated point or section from among a plurality of the uploaded videos.

In addition, another aspect of the present disclosure is a computer-readable storage medium that non-transitorily stores the program described above.

According to the present disclosure, the convenience for the user of the vehicle can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram describing an outline of a video sharing system;

FIG. 2 is a diagram showing constituent elements of a drive recorder 100;

FIG. 3 is a diagram for describing data generated by the drive recorder 100;

FIG. 4 is a diagram showing constituent elements of a user terminal 200;

FIG. 5 is a diagram for describing a video editing function provided by the user terminal 200;

FIG. 6 is a diagram for describing drive recorder data generated by the user terminal 200;

FIG. 7 is a diagram showing constituent elements of a server device 300;

FIG. 8 is a map for describing a route corresponding to an in-vehicle video;

FIG. 9 is an example of a screen of a video sharing service;

FIG. 10 is an example of a video database stored by the server device 300;

FIG. 11 is a flowchart of processing executed by the drive recorder 100;

FIG. 12 is a sequence diagram showing processing of uploading the drive recorder data;

FIG. 13 is a sequence diagram showing processing of searching for the in-vehicle video;

FIG. 14 is an example of a screen for a second user to designate a point;

FIG. 15 is a map for describing comparison processing of position information;

FIG. 16 is a schematic diagram of drive recorder data in a second embodiment;

FIG. 17A is an example of a video database in the second embodiment;

FIG. 17B is an example of a video database in a third embodiment;

FIG. 18 is an example of a screen for designating a vehicle attribute in the second embodiment;

FIG. 19 is a schematic diagram of drive recorder data in the third embodiment; and

FIG. 20 is an example of a screen for designating an environment attribute in the third embodiment.

### DETAILED DESCRIPTION OF EMBODIMENTS

In the related art, in order to extract a video from a drive recorder, it is needed to copy a file via a medium, such as a memory card. On the other hand, in recent years, many drive recorders capable of wireless connection are sold. As a result, it is possible to more easily share a captured video with others (for example, upload the captured video to a video posting site). In the following description, a video captured by an in-vehicle camera, such as a drive recorder, is referred to as an in-vehicle video.

In a case where a plurality of in-vehicle videos is opened, for example, it is possible to preview a drive route in advance, so that the convenience for a user who drives an automobile is improved.

An information processing device according to the present disclosure further improves the convenience for the user who views the in-vehicle video.

The information processing device according to one aspect of the present disclosure includes a storage unit configured to store video information that is information on a video captured by an in-vehicle camera and uploaded by a first user, and a controller configured to execute accepting designation of a point or a section from a second user, and extracting a first video including the designated point or section from among a plurality of the uploaded videos.

The video information may include, for example, information indicating a location of a video file (a network address or the like), or may include route information of a vehicle that captures the in-vehicle video. In addition, the video information may include information on a capturing environment of the in-vehicle video.

The controller extracts the video (first video) including the point or the section designated by the second user from among the uploaded videos. The extraction can be executed by referring to the video information, for example.

With such a configuration, it is possible to provide the in-vehicle video including the point or section that the second user wants to view to the second user. As a result, for example, it is possible to efficiently execute preview of the drive route.

Note that the extraction of the first video may be executed by using information other than the point or the section. For example, the video information may include information (for example, a vehicle model or a size) on the vehicle that captures the in-vehicle video, and filtering may be executed by using the information. With such a form, it is possible to check whether or not there is a track record of a vehicle having a designated vehicle class passing through a specific point or section.

In addition, the extraction of the first video may be executed by using information on the environment. For example, the video information may include information on a traveling environment at the time of capturing (for example, a time zone or weather), and filtering may be executed by using the information. With such a form, for example, it is possible to “search for the in-vehicle video captured in the designated time zone” or “search for the in-vehicle video captured under the designated weather”. In addition, in a case where the second user is expected to be moved under a predetermined environment, it is possible to provide the in-vehicle video suitable for the environment. For example, in a case where the second user is estimated to be moved at night, it is possible to provide the in-vehicle video captured at night.

In the following, specific embodiments of the present disclosure will be described based on the drawings. A hardware configuration, a module configuration, a functional configuration, and the like described in each embodiment are not intended to limit the technical scope of the disclosure solely thereto unless otherwise specified.

### First Embodiment

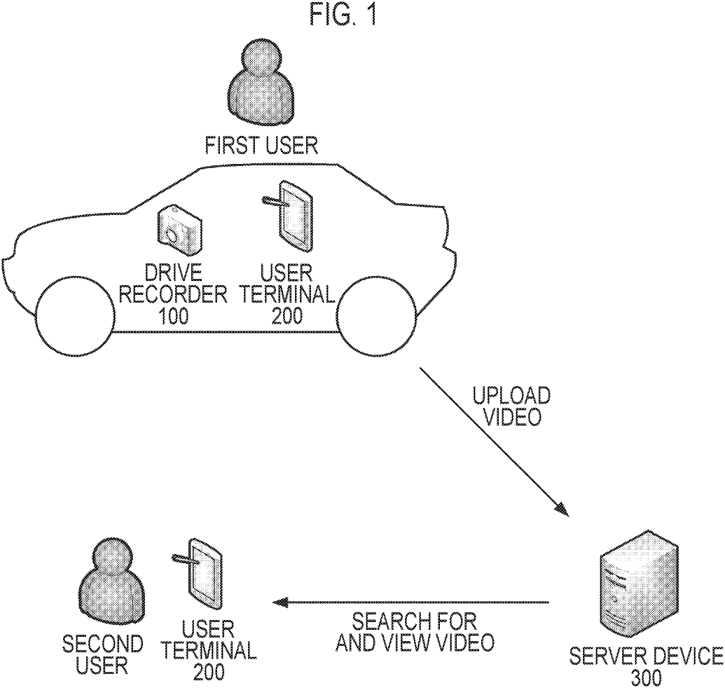

An outline of a video sharing system according to a first embodiment will be described with reference to FIG. 1.

A video sharing system according to the present embodiment is a system used by the first user and the second user. The first user is a user who captures the in-vehicle video and uploads the captured in-vehicle video to a server device 300. The first user owns a drive recorder 100 and a user terminal 200, and the first user uses the user terminal 200 to upload the in-vehicle video.

The second user is a user who views the in-vehicle video uploaded by the first user. The second user transmits information for designating a desired point or section to the server device 300 and searches for the in-vehicle video. The server device 300 extracts a suitable in-vehicle video from a database and provides the extracted in-vehicle video to the second user.

The drive recorder 100 is a device that captures a video and is equipped in the vehicle. The drive recorder 100 continuously captures the video while the vehicle is traveling, and accumulates the video in a storage device.

The user terminal 200 is a portable terminal used by a user associated with the vehicle. The user terminal 200 has a function of acquiring the in-vehicle video in a state of being connected to the drive recorder 100. The user terminal 200 can be wirelessly connected to the drive recorder 100 to acquire the in-vehicle video. In addition, the user terminal 200 has a function of uploading the acquired in-vehicle video to the server device 300.

Further, the user terminal 200 has a function of accessing the server device 300 to search for and view the uploaded in-vehicle video. The first user can use the user terminal 200 to upload the in-vehicle video, and the second user can use the user terminal 200 to view the in-vehicle videos uploaded by other users.

The server device 300 is a device that provides a video sharing service. The server device 300 can store and open the in-vehicle video uploaded by the user terminal 200 owned by the first user. The server device 300 may be configured to execute a web service for sharing the in-vehicle video. The second user can access the web service to search for and view the in-vehicle videos uploaded by a plurality of first users.

In addition, when the server device 300 receives the in-vehicle video, the server device 300 simultaneously receives information on a route of the vehicle that captures the in-vehicle video, and holds the in-vehicle video and the information in association with each other. As a result, it is possible to provide a service that searches for the in-vehicle video including the designated point (or section).

Each of the drive recorder 100, the user terminal 200, and the server device 300 will be described in detail.

The drive recorder 100 is a device that is equipped in the vehicle and captures the in-vehicle video. The drive recorder 100 is fixed with a camera facing the front of the vehicle, receives power supply from the vehicle to regularly capture the video, and records the obtained video data in the storage device.

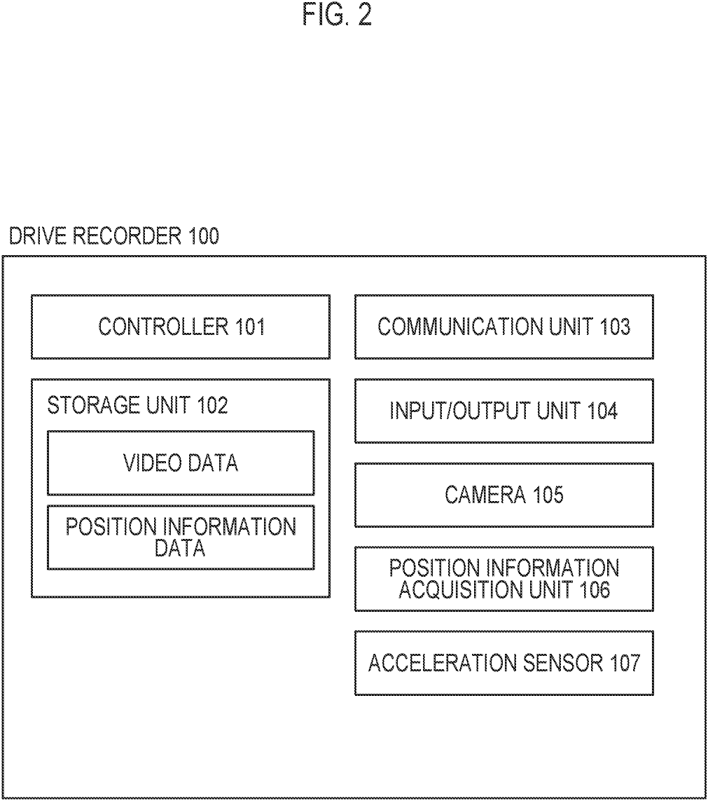

FIG. 2 is a diagram showing a system configuration of the drive recorder 100.

The drive recorder 100 includes a controller 101, a storage unit 102, a communication unit 103, an input/output unit 104, a camera 105, a position information acquisition unit 106, and an acceleration sensor 107.

The controller 101 is an arithmetic device that administers the control executed by the drive recorder 100. The controller 101 can be realized by an arithmetic processing device, such as a central processing unit (CPU).

During the operation, the controller 101 executes a function of capturing the video via the camera 105 to be described below and storing the obtained video data in the storage unit 102. In addition, based on an instruction from the user terminal 200, the controller 101 executes a function of transferring the stored data to the user terminal 200.

The storage unit 102 is a memory device including a main storage device and an auxiliary storage device. An operating system (OS), various programs, various tables, and the like are stored in the auxiliary storage device, and the programs stored in the auxiliary storage device are loaded into the main storage device and executed, so that each function that matches a predetermined purpose as described below can be realized.

The main storage device may include a random access memory (RAM) or a read only memory (ROM). In addition, the auxiliary storage device may include an erasable programmable ROM (EPROM) or a hard disk drive (HDD). Further, the auxiliary storage device may include a removable medium, that is, a portable recording medium.

The data generated by the controller 101 is stored in the storage unit 102.

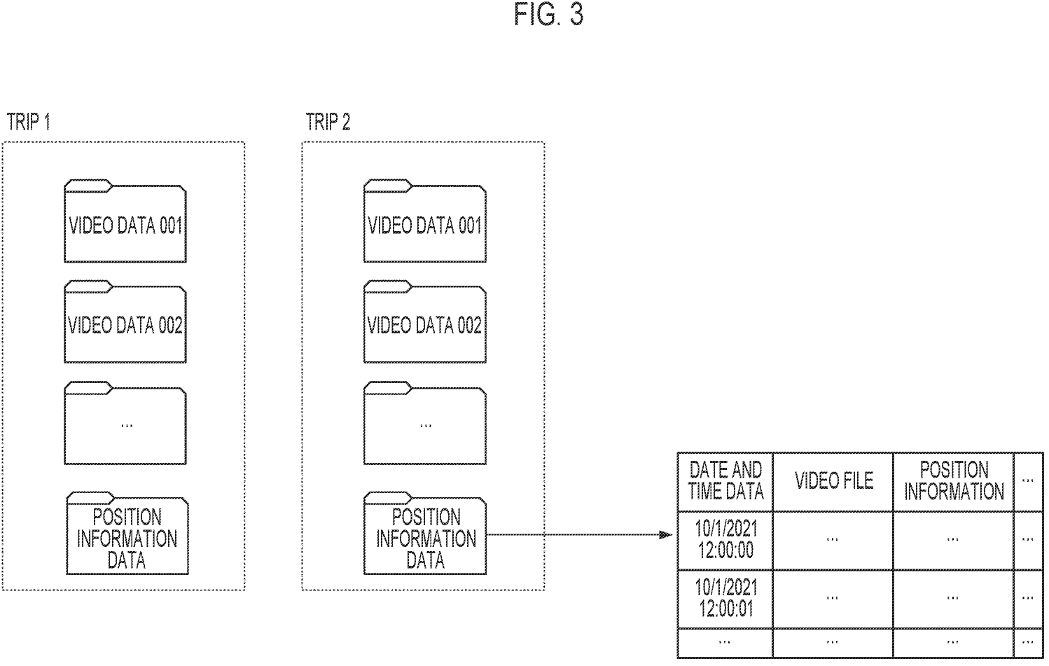

Here, the data stored in the storage unit 102 will be described. FIG. 3 is a diagram showing a structure of the data generated by the controller 101 and stored in the storage unit 102.

Note that, in the following description, the term “trip” is used as a term representing the unit of traveling from when a system power supply of the vehicle is turned on to when the system power supply is cut off.

In a case where the system power supply of the vehicle is turned on, the controller 101 generates a storage area (for example, a folder and a directory) corresponding to a new trip. The generated data is stored in the storage area until the system power supply of the vehicle is cut off.

The controller 101 captures the video via the camera 105 while the power is being supplied to drive recorder 100, and stores the obtained data (video data) in the storage unit 102. The video data is stored in a unit of a file. There is an upper limit (for example, one minute, five minutes) to a length of the video corresponding to one file, and in a case where the length exceeds the upper limit, a new file is generated. Note that, in a case where a storage capacity is insufficient, the controller 101 deletes the oldest file to secure a free space and then continues capturing.

Further, the controller 101 acquires position information of the vehicle via the position information acquisition unit 106 at a predetermined cycle (for example, every second) and stores the acquired position information as position information data.

The video data and the position information data are stored for each trip as shown in FIG. 3. By storing both the video data and the position information data, it is possible to specify a traveling position of the vehicle afterwards.

The communication unit 103 is a wireless communication interface for connecting the drive recorder 100 to a network. The communication unit 103 is configured to communicate with the user terminal 200 in accordance with a communication standard, such as a wireless LAN or Bluetooth (registered trademark).

The input/output unit 104 is a unit that accepts an input operation executed by the user and presents the information to the user. The input/output unit 104 includes, for example, a liquid crystal display, a touch panel display, or a hardware switch.

The camera 105 is an optical unit including an image sensor for acquiring an image.

The position information acquisition unit 106 calculates the position information based on a positioning signal transmitted from a positioning satellite (also referred to as a GNSS satellite). The position information acquisition unit 106 may include an antenna that receives radio waves transmitted from the GNSS satellite.

The acceleration sensor 107 is a sensor that measures acceleration applied to the device. A measurement result is supplied to the controller 101, so that the controller 101 can determine that an impact is applied to the vehicle.

Then, the user terminal 200 will be described.

The user terminal 200 is a computer used by the user associated with the vehicle. The user can download the video from the drive recorder 100 via the user terminal 200 and upload the video to the video sharing service provided by the server device 300. In addition, the user can search for and view the video uploaded to the server device 300 via the user terminal 200. The user terminal 200 is, for example, a personal computer, a smart phone, a portable phone, a tablet computer, or a personal information terminal.

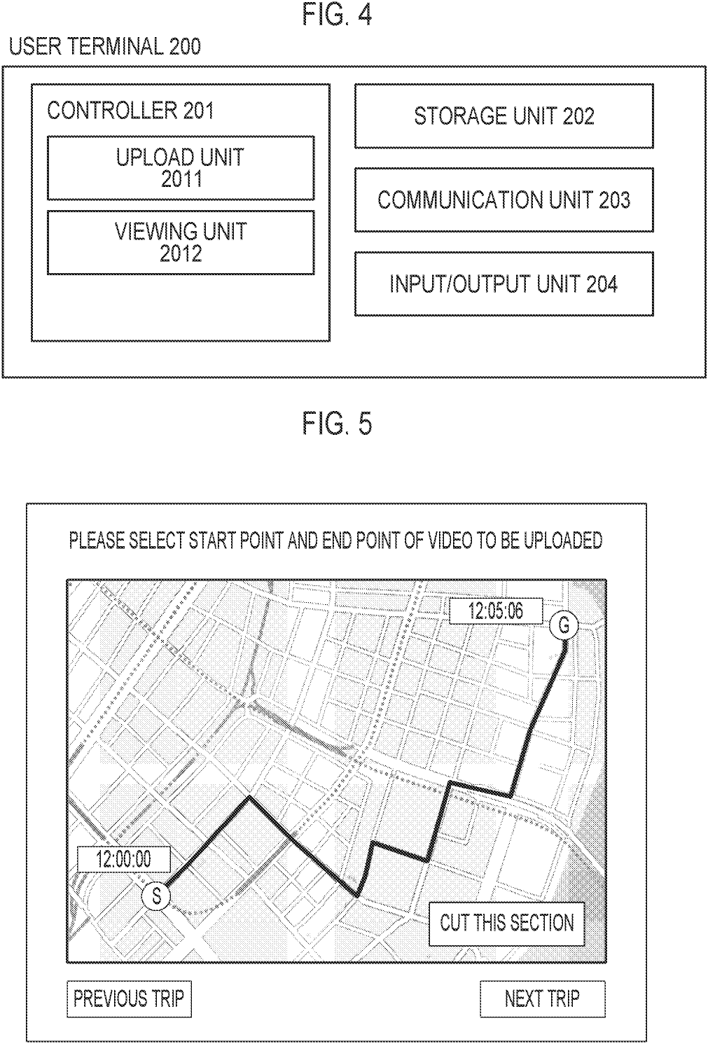

FIG. 4 is a diagram showing a system configuration of the user terminal 200.

The user terminal 200 includes a controller 201, a storage unit 202, a communication unit 203, and an input/output unit 204.

The controller 201 is an arithmetic device that administers the control executed by the user terminal 200. The controller 201 can be realized by an arithmetic processing device, such as a central processing unit (CPU).

The controller 201 accesses the server device 300 and executes a function of executing interaction with the server device 300. The function may be realized by a web browser operating on the user terminal 200 or dedicated application software.

In the present embodiment, the controller 201 is configured to execute the application software for executing the interaction with the server device 300.

The controller 201 includes two functional modules, an upload unit 2011 and a viewing unit 2012. Each functional module may be realized by executing the stored program by a CPU.

The upload unit 2011 acquires the video data from the drive recorder 100 and uploads the acquired video data to the server device 300.

Specifically, (1) a function of executing cut editing for the video stored in the drive recorder 100 and (2) a function of uploading the cut video to the server device 300 are executed.

Each function will be described in order.

The upload unit 2011 presents a traveling route to the user based on the data stored in the drive recorder 100, and accepts designation of a range for the cut editing. As described with reference to FIG. 3, the drive recorder 100 stores the video data and the position information data in association with each other for each trip. Based on these data, the upload unit 2011 can generate a user interface representing the traveling route and execute the cut editing of the video. FIG. 5 is an example of a user interface screen output in a case where the cut editing is executed.

In a case where the user designates the range of the trip and the video, the corresponding range is cut out to generate data to be transmitted to server device 300.

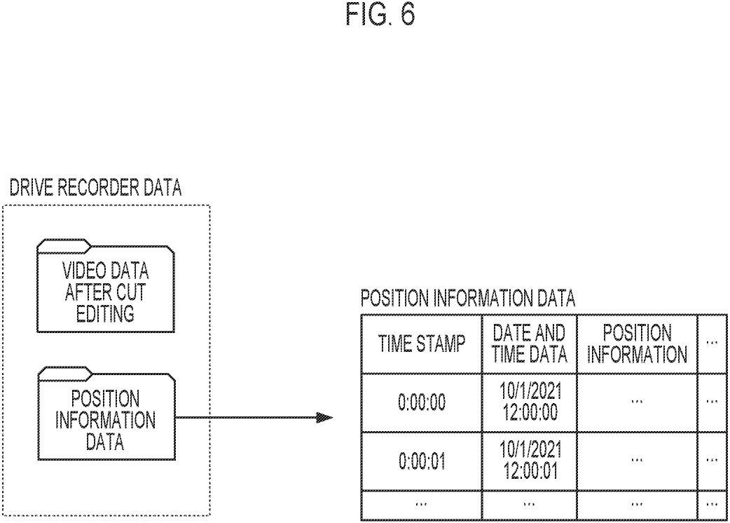

FIG. 6 is a diagram for describing the data generated by the upload unit 2011. Here, a set of the data transmitted from the user terminal 200 to the server device 300 is referred to as drive recorder data. The drive recorder data includes the video data after the cut editing and the position information data corresponding to the video data. The position information data includes time stamp information corresponding to the video subjected to the cut editing. By associating these two of the video data and the position information data, the server device 300 can specify a geographical position corresponding to any point in time (time stamp) on a timeline of the in-vehicle video.

The viewing unit 2012 executes a function of searching for the in-vehicle video uploaded to the server device 300 and a function of reproducing the in-vehicle video designated by the user.

Specifically, the viewing unit 2012 accepts the designation of the point or the section from the user, and requests the server device 300 to search for the in-vehicle video including the point or the section. In addition, the viewing unit 2012 receives a search result from the server device 300 and outputs the search result via the input/output unit 204.

In addition, the viewing unit 2012 requests the server device 300 to reproduce the in-vehicle video designated by the user, and reproduces the in-vehicle video based on the data transmitted from the server device 300.

The storage unit 202 includes a main storage device and an auxiliary storage device. The main storage device is a memory in which a program executed by the controller 201 or data used in the program is expanded. The auxiliary storage device is a device in which the program executed by the controller 201 and the data used in the program are stored. The auxiliary storage device may store the program that is packaged as an application to be executed by the controller 201. In addition, an operating system for executing these applications may be stored. The program stored in the auxiliary storage device is loaded into the main storage device and executed by the controller 201 to execute processing described below.

The main storage device may include a random access memory (RAM) or a read only memory (ROM). In addition, the auxiliary storage device may include an erasable programmable ROM (EPROM) or a hard disk drive (HDD). Further, the auxiliary storage device may include a removable medium, that is, a portable recording medium.

The communication unit 203 is a wireless communication interface for connecting the user terminal 200 to the network. The communication unit 203 is configured to communicate with the drive recorder 100 and the server device 300 via, for example, a wireless LAN, a 3G, an LTE, a 50, or other mobile communication services. Note that the communication unit 203 may include both a communication interface for communicating with the drive recorder 100 and a communication interface for communicating with the server device 300. The former may be a communication interface that uses near field wireless communication or the like, and the latter may be a communication interface that uses mobile communication or the like.

The input/output unit 204 is a unit that accepts an input operation executed by the user and presents the information to the user. In the present embodiment, the input/output unit 204 is formed of one touch panel display. Specifically, the input/output unit 204 is configured by a touch panel and control means thereof, and a liquid crystal display and control means thereof.

Then, the server device 300 will be described.

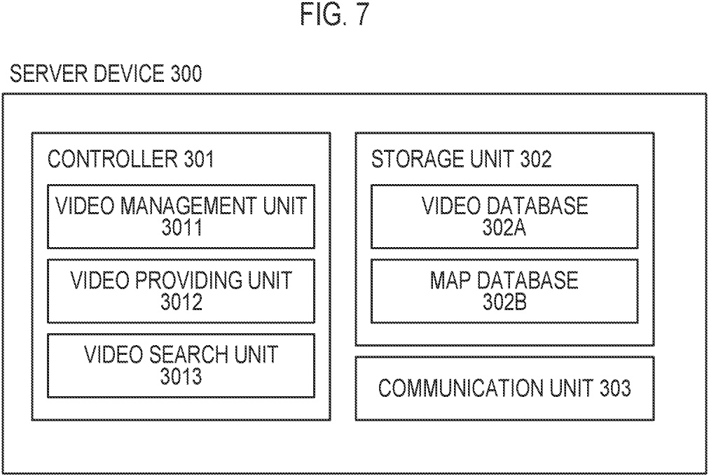

FIG. 7 is a diagram showing constituent elements of the server device 300 provided in the video sharing system according to the present embodiment in detail.

The server device 300 is a device that provides a service (video sharing service) for sharing the videos uploaded from the user terminals 200 among a plurality of users.

In addition, the server device 300 provides a service of searching for the in-vehicle video based on the point (or section) designated by the user. For example, in a case where the user designates the point or section to be checked in the video, the server device 300 searches for the in-vehicle video including the point or the section and provides the in-vehicle video to the user. Specific processing will be described below.

The server device 300 can be configured by a general-purpose computer. That is, the server device 300 can be configured as a computer including a processor, such as a CPU or a GPU, a main storage device, such as a RAM or a ROM, and an auxiliary storage device, such as an EPROM, a hard disk drive, or a removable medium. An operating system (OS), various programs, various tables, and the like are stored in the auxiliary storage device, the programs stored in the auxiliary storage device are loaded into a work area of the main storage device and executed, and the constituent units are controlled through the execution of the programs, so that each function that matches a predetermined purpose as described below can be realized. Note that a part or all of the functions may be realized by a hardware circuit, such as an ASIC or an FPGA.

In the present embodiment, the server device 300 may be configured to execute a software server for executing the interaction with the user terminal 200. In this case, for example, the user terminal 200 can execute input/output of the information by accessing the service using the browser or the dedicated application software.

The server device 300 includes a controller 301, a storage unit 302, and a communication unit 303.

The controller 301 is an arithmetic device that administers the control executed by the server device 300. The controller 301 can be realized by an arithmetic processing device, such as a CPU.

The controller 301 includes three functional modules, a video management unit 3011, a video search unit 3013, and a video providing unit 3012. Each functional module may be realized by executing the stored program by a CPU.

The video management unit 3011 executes processing of accepting uploading of the in-vehicle video from the user terminal 200 used by the first user.

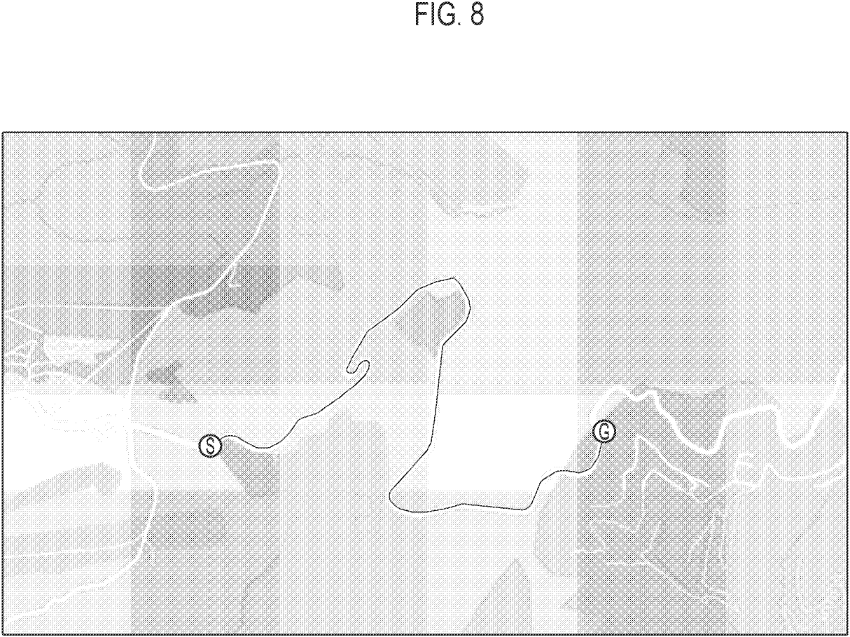

The video management unit 3011 acquires the drive recorder data generated by the user terminal 200. As described with reference to FIG. 6, the drive recorder data includes the video data after the cut editing and the position information data corresponding to the video data. As a result, it is possible to associate an elapsed time (time stamp) on the timeline with the position information. FIG. 8 is a map showing an example of the traveling route associated with the in-vehicle video. In the shown example, S means a start point of the in-vehicle video, and G means an end point of the in-vehicle video. By associating the elapsed time on the timeline with the position information, it is possible to grasp, on a side of the server device 300, the traveling route corresponding to the in-vehicle video.

The video providing unit 3012 provides the in-vehicle video designated by the user based on the request from the user terminal 200. The video providing unit 3012 provides the in-vehicle video by using, for example, a video player that is operated on the browser.

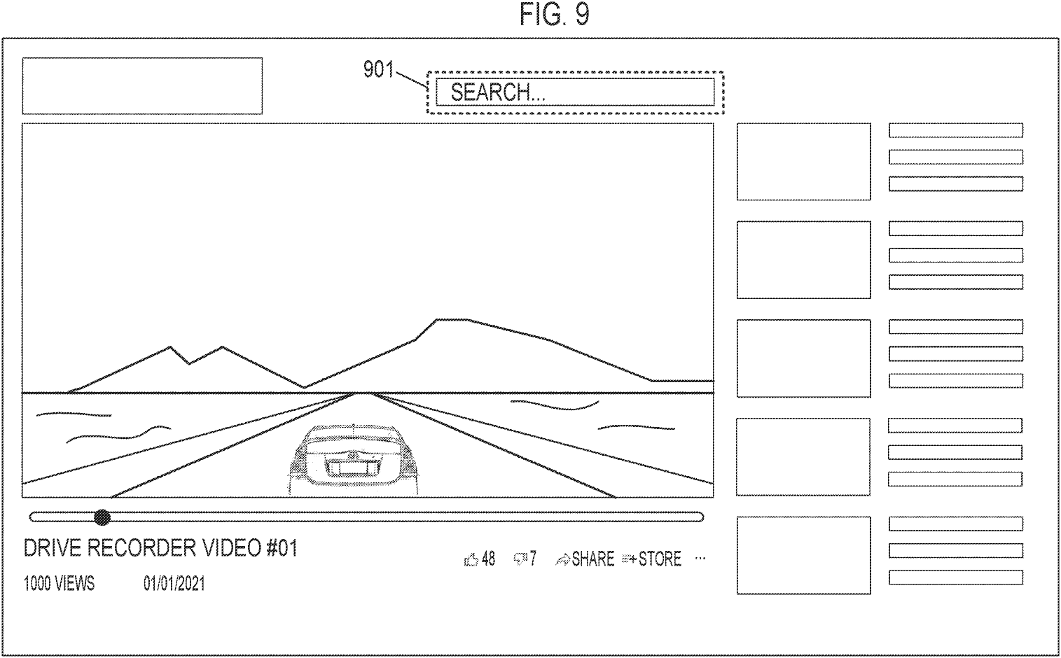

FIG. 9 is an example of a screen provided in the video sharing service. As shown in FIG. 9, a part (reference numeral 901) for searching for the in-vehicle video, a part for evaluating the in-vehicle video, a reproduction controller, an area for outputting a related video, and the like are disposed on the screen. Note that map information as shown in FIG. 8 may be inserted into a reproduction screen of the in-vehicle video.

The video search unit 3013 acquires the request to search for the in-vehicle video (hereinafter referred to as a search request) from the user terminal 200, and extracts the in-vehicle video that hits the request from among the stored in-vehicle videos. The search request may be a search query sentence written in natural language. The video search unit 3013 can search for the in-vehicle video including the written search query sentence in a title, an outline, description, and the like.

In addition, the search request may include information for designating the point or a road section. For example, a road name, a point name, an intersection name, and a spot (landmark) name may be written in natural language. Based on these pieces of information, the video search unit 3013 can specify a specific point or road section, and search for the in-vehicle video including the point (or section). Search results are listed and transmitted to the user terminal 200.

Returning to FIG. 7, the description is continued.

The storage unit 302 includes a main storage device and an auxiliary storage device. The main storage device is a memory in which a program executed by the controller 301 or data used in the control program are expanded. The auxiliary storage device is a device in which the program executed by the controller 301 or the data used in the control program are stored.

In addition, the storage unit 302 includes a video database 302A and a map database 302B.

The video database 302A is a database that stores the in-vehicle video uploaded from the user terminal 200. The video database 302A includes additional data related to the in-vehicle video in addition to the drive recorder data described with reference to FIG. 6.

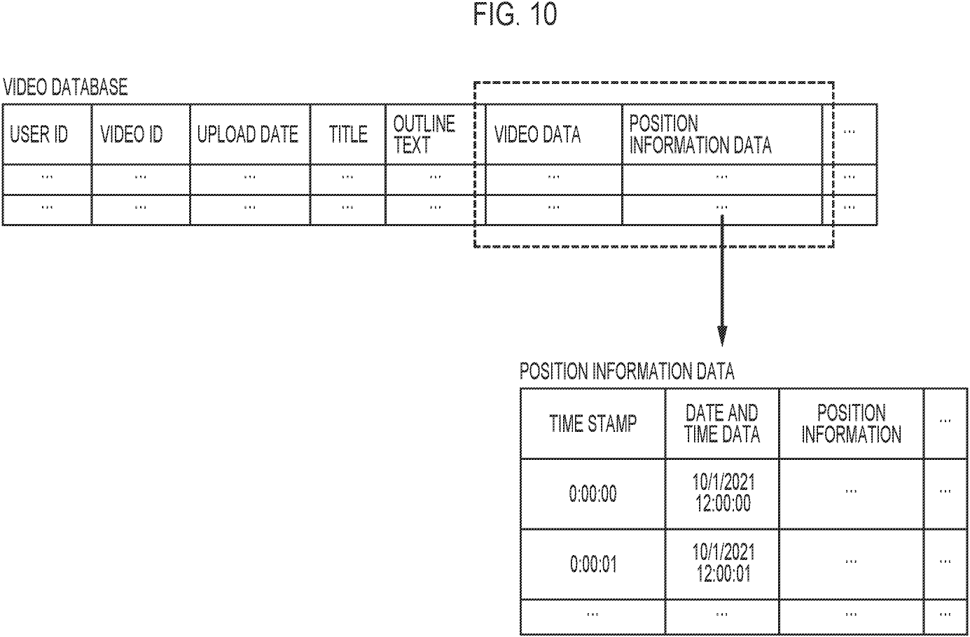

FIG. 10 is an example of the data stored in the video database 302A. The video database 302A stores an ID of the user who uploads the in-vehicle video, an ID of the video assigned by the server device 300, an upload date of the in-vehicle video, a title of the in-vehicle video input by the first user, an outline text, and the like. In addition, the video database 302A stores the drive recorder data, that is, the video data and the position information data (shown by dotted lines).

The information stored in the video database 302A is referred to as the video information.

The map database 302B is a database that stores a road map. The road map includes definition of a road segment. The road segment is a unit section obtained by dividing the road into predetermined lengths. Each road segment is associated with the position information (latitude and longitude), an address, a point name, a road name, and the like. These pieces of information are used as indexes in a case where the in-vehicle video is searched for.

Returning to FIG. 7, the description is continued.

The communication unit 303 is a communication interface for connecting the server device 300 to the network. The communication unit 303 includes, for example, a network interface board or a wireless communication interface for wireless communication.

Note that the configurations shown in FIGS. 2, 4, and 7 are examples, and all or a part of the shown functions may be executed by using a circuit exclusively designed. In addition, the program may be stored or executed by a combination of the main storage device and the auxiliary storage device other than the configurations shown in FIGS. 2, 4, and 7.

Then, details of processing executed by each device included in the video sharing system will be described.

FIG. 11 is a flowchart of the processing executed by the drive recorder 100. The shown processing is repeatedly executed by the controller 101 while power is being supplied to the drive recorder 100.

In step S11, the controller 101 uses the camera 105 to capture the video. In this step, the controller 101 records a video signal output from the camera 105 in the file as the video data. As described with reference to FIG. 3, the file is divided into predetermined lengths. Note that, in a case where the storage area of the storage unit 102 is insufficient, the oldest files are overwritten in order. In addition, in this step, the controller 101 periodically acquires the position information via the position information acquisition unit 106, and records the acquired position information in the position information data (see FIG. 3).

In step S12, the controller 101 determines whether or not a protection trigger is generated. For example, in a case where an impact is detected by the acceleration sensor 107 or in a case where the user presses a storage button provided on a main body of the drive recorder, the protection trigger is generated. In this case, the processing transitions to step S13, and the controller 101 moves the file currently being recorded to a protection area. The protection area is an area in which the file is not automatically overwritten. As a result, it is possible to protect the file that records a major scene. In a case where the protection trigger is not generated, the processing returns to step S11 to continue the capturing.

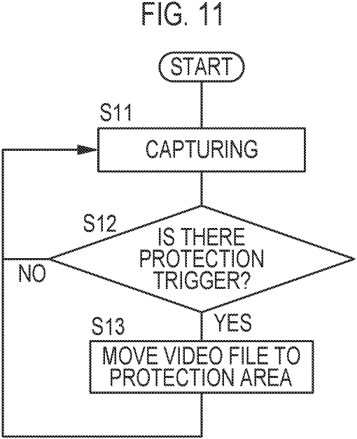

Then, the processing of uploading the in-vehicle video captured by the drive recorder 100 to the server device 300 will be described. FIG. 12 is a sequence diagram of the processing executed by the drive recorder 100, the user terminal 200, and the server device 300 in the processing.

First, the user terminal 200 establishes the connection with the drive recorder 100. The connection can be executed by ad-hoc radio, for example.

In a case where the connection is established, the drive recorder 100 acquires the information associated with the recorded video for each trip (step S21). Examples of such information include capturing date and time and a set of the position information. The acquired information is transmitted to the user terminal 200.

In step S22, the user terminal 200 outputs the user interface for executing the cut editing of the in-vehicle video based on the acquired information. In this step, a user interface screen as shown in FIG. 5 is output, and the user uses the user interface screen to execute the cut editing of the in-vehicle video. For example, the user designates the trip and then designates the start point and the end point from the route corresponding to the designated trip. As a result, it is possible to cut the in-vehicle video of the section desired by the user. Note that, in a case where the user designates the point on the route on the user terminal 200, the drive recorder 100 may provide a preview screen of the video corresponding to the point.

An instruction for the cut editing is transmitted to the drive recorder 100, and the drive recorder 100 cuts the video data in response to the instruction (step S23). The controller 101 adds the time stamp corresponding to the cut video data to the position information data to generate the drive recorder data. The generated drive recorder data is transmitted to the user terminal 200.

Then, in step S24, the user terminal 200 acquires additional information. The additional information is additional information for describing the in-vehicle video. The additional information includes, for example, the title of the in-vehicle video, a sentence describing the outline, and a tag for search. These pieces of information may be input by the user. The drive recorder data and the additional information are transmitted to the server device 300.

In step S25, the server device 300 (video management unit 3011) stores the uploaded drive recorder data and the additional information in the video database 302A, and opens the video. As a result, it is possible for the second user to search for and view the in-vehicle video.

Then, processing for the second user to view the in-vehicle video will be described.

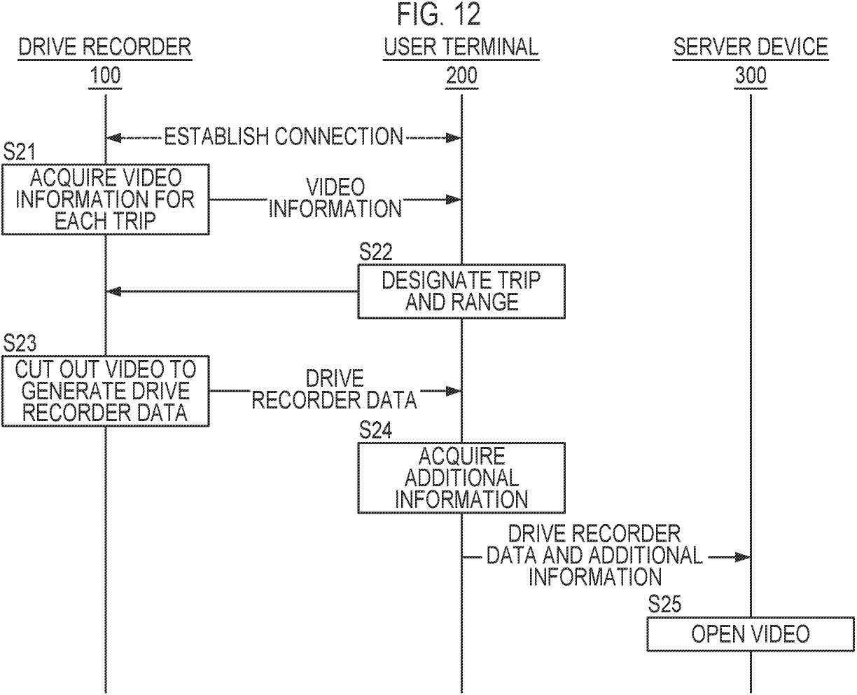

FIG. 13 is a sequence diagram of the processing executed between the user terminal 200 used by the second user and the server device 300.

In a case where the second user uses the user terminal 200 to access the video sharing service provided by the server device 300, the server device 300 provides a user interface screen for searching for the in-vehicle video. By using the user interface screen, the second user can search for a desired in-vehicle video.

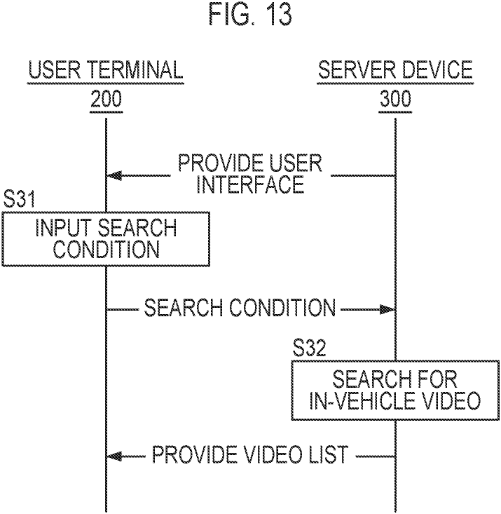

In step S31, the user terminal 200 (controller 201) accepts input of a search condition. The search may be executed by using a keyword, or may be executed by designating the route, a point to be passed through, a section to be passed through, or the like. For example, the user terminal 200 may output the road map and allow the designation of a desired point, road section, range, route, or the like on the map. FIG. 14 is an example of a screen output by the user terminal 200.

The input search condition is transmitted to the server device 300.

In step S32, the server device 300 (video search unit 3013) searches for the in-vehicle video in accordance with the designated search condition.

In a case where the point is designated as the search condition, the video search unit 3013 converts the designated point into the position information (latitude and longitude). For example, in a case where the point is designated by the keyword, the video search unit 3013 converts the designated point into the position information by geocoding, for example. Moreover, the video search unit 3013 extracts the in-vehicle video that can be evaluated as passing through designated point (or section) from the video database 302A.

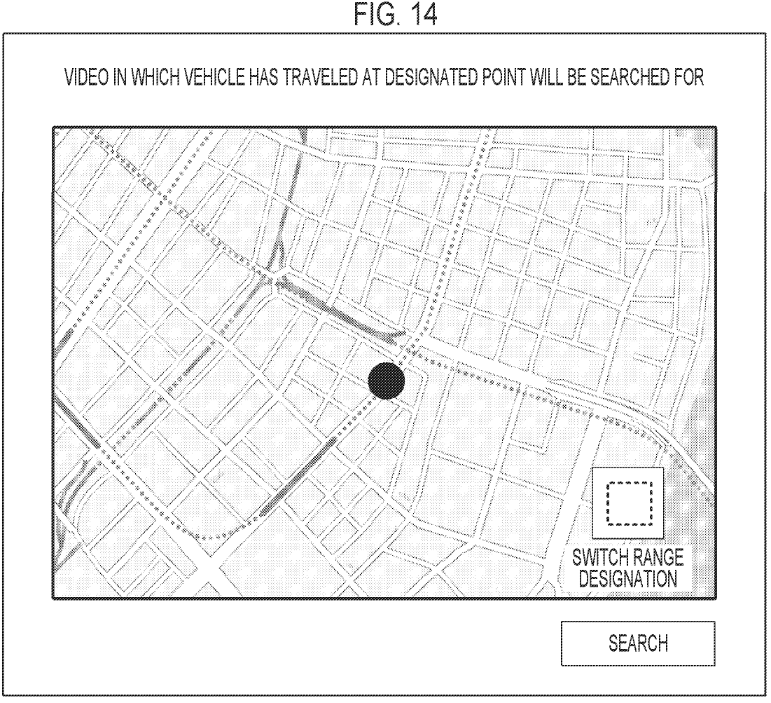

This processing can be executed by comparing the position information recorded in the video database 302A and the position information corresponding to the designated point. FIG. 15 is a map for describing a comparison method of the position information. Here, a reference numeral 1501 is the point designated by the second user, and a reference numeral 1502 is the traveling route of the vehicle (vehicle that captures the in-vehicle video) derived from the position information associated with a certain in-vehicle video. A reference numeral 1503 is a predetermined range centered on the point designated by the second user. In a case where the traveling route of the vehicle is included in the range, the video search unit 3013 can determine that the in-vehicle video hits the search condition.

Note that, in a case where the road section or the range is designated as the search condition, the video search unit 3013 may convert the designated road section or range into a set of a plurality of pieces of position information, and may use the plurality of pieces of position information to make the determination described above.

For example, in a case where a certain road section (range) is designated by the second user, at least one of the position information included in the road section (range) is used to make the determination as described above. As a result, it is possible to extract the in-vehicle video that passes through the designated road section (range).

A list of the in-vehicle videos obtained as a result of the search is provided to the user terminal 200.

In a case where the second user selects the desired in-vehicle video, the server device 300 (video providing unit 3012) generates the user interface screen including the video player and starts reproducing the in-vehicle video.

As described above, the server device 300 according to the first embodiment stores the in-vehicle video uploaded by the first user in association with the route information of the vehicle that captures the in-vehicle video. As a result, it is possible to search for the in-vehicle video by using the position information.

With such a configuration, for example, it is possible to preview the drive route in advance, so that the convenience for the user who drives the automobile is improved.

### Second Embodiment

A second embodiment is an embodiment in which the uploaded in-vehicle video is further associated with data related to the vehicle that captures the in-vehicle video, and stored in the server device 300.

In the first embodiment, the in-vehicle video is searched for based on the position information. However, in a case where the first user captures the in-vehicle video by using a small-sized vehicle and the second user drives a large-sized vehicle, there may be cases where an appropriate preview of the drive route cannot be made. The reason is that even in a case where the route is difficult for the large-sized vehicle to pass through or pass by, when the position information is suitable, the route will be a target of the search.

In order to handle this case, in the second embodiment, an attribute related to the vehicle (vehicle attribute) is further associated with the in-vehicle video, and the vehicle attribute is further used to execute the search.

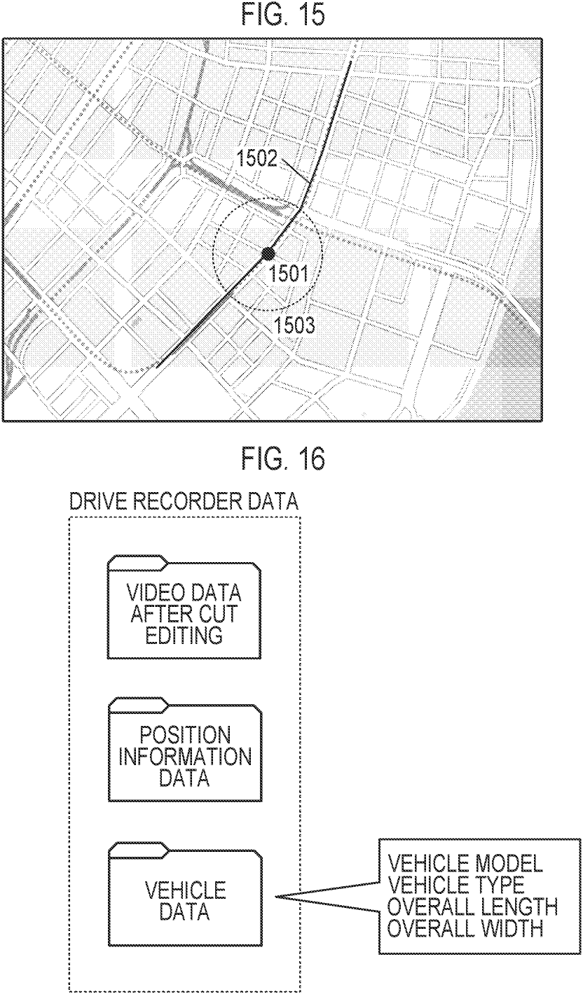

FIG. 16 is a schematic diagram of the drive recorder data in the second embodiment. In the present embodiment, the drive recorder data includes vehicle data in addition to the video data and the position information data. The vehicle data is data related to the attribute of the vehicle in which the drive recorder 100 is mounted. Examples of the attribute of the vehicle include the vehicle model and the vehicle class (size). Note that the data related to the attribute of the vehicle may be added by the drive recorder 100 or may be added by the user terminal 200.

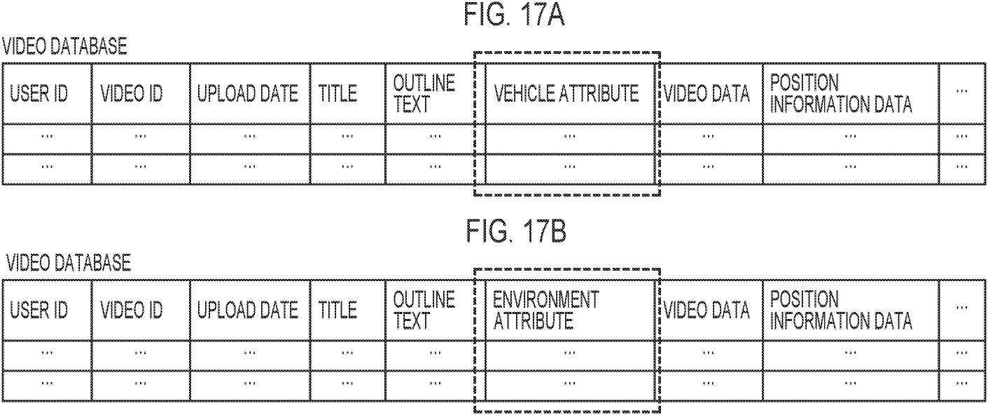

The server device 300 that receives the drive recorder data stores the vehicle attribute in association with the in-vehicle video. FIG. 17A is an example of the video database in the second embodiment.

In addition, in the second embodiment, the designation of the vehicle attribute is added to the search condition. FIG. 18 is an example of a screen on which the user terminal 200 accepts the input of the search condition in step S31. In the second embodiment, as indicated by a reference numeral 1801, the user interface for narrowing down by the vehicle attribute is provided. The vehicle attribute may be designated by the vehicle class (light automobile, small-sized vehicle, medium-sized vehicle, large-sized vehicle, or the like), or may be designated by a vehicle width, an overall length, a wheelbase, or the like.

In addition, in the second embodiment, in step S32, the server device 300 narrows down the in-vehicle video by the designated vehicle attribute. For example, in a case where the user designates the “light automobile”, then the in-vehicle video captured by the drive recorder mounted on the light automobile is extracted.

In the second embodiment, as described above, the vehicle attribute is added to the search condition, so that it is possible to search for a more appropriate in-vehicle video (for example, the in-vehicle video captured by the vehicle having the same vehicle class as the vehicle driven by the second user).

### Third Embodiment

A third embodiment is an embodiment in which data related to the traveling environment is further associated with the uploaded in-vehicle video, and stored in the server device 300.

In the third embodiment, the in-vehicle video is further associated with an attribute (environment attribute) related to the traveling environment of the vehicle that captures the in-vehicle video, and environment attribute is further used to execute the search.

Examples of the environment attributes include the weather or the time zone. In a case where the weather is used as the environment attribute, for example, it is possible to search for “in-vehicle video captured during snowfall”. In addition, in a case where the time zone is used as the environment attribute, for example, it is possible to search for “in-vehicle video captured after sunset”.

Note that the environment attribute may be anything other than the weather or the time zone as long as the environment attribute relates to the traveling environment of the vehicle that captures the in-vehicle video.

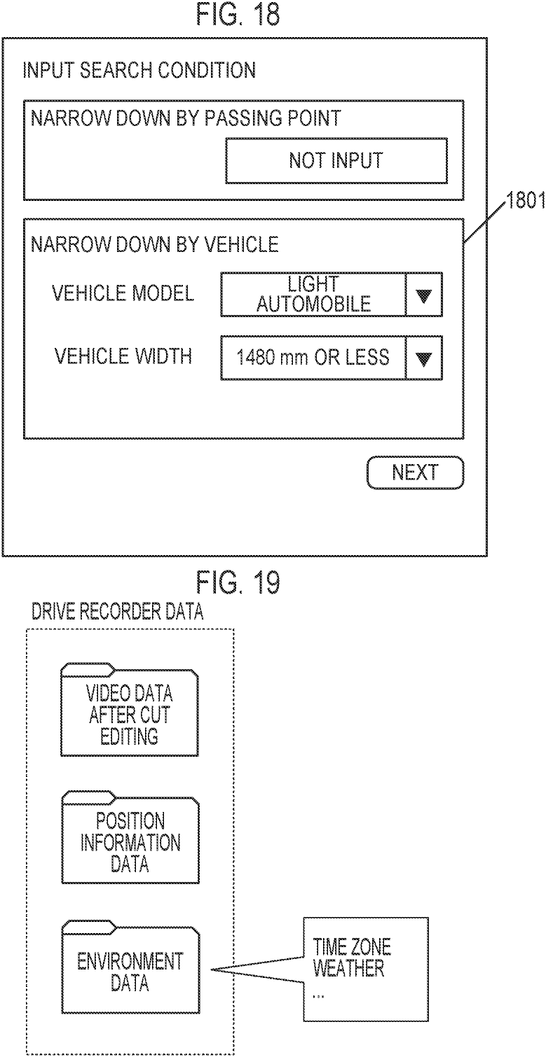

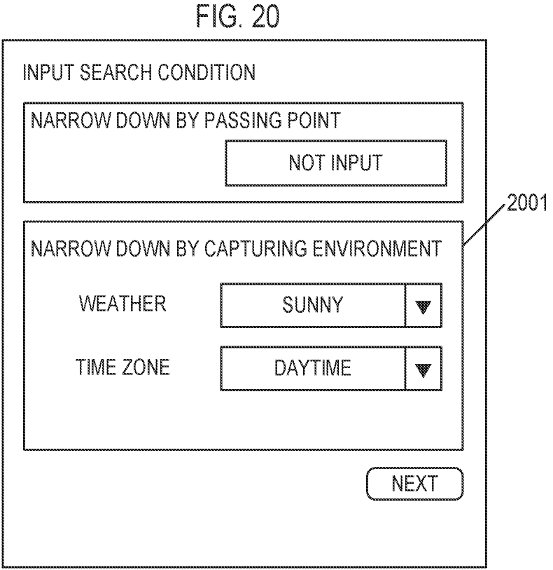

FIG. 19 is a schematic diagram of the drive recorder data in the third embodiment. In the present embodiment, the drive recorder data includes environment data in addition to the video data and the position information data. The environment data is data related to the traveling environment of the vehicle that captures the in-vehicle video. In the third embodiment, the controller 101 generates such drive recorder data and stores the generated drive recorder data in the storage unit 102. The environment data can be acquired, for example, from a sensor or an ECU provided in a vehicle platform.

The server device 300 that receives the drive recorder data stores the environment attribute in association with the in-vehicle video. FIG. 17B is an example of the video database in the third embodiment.

In addition, in the third embodiment, designation of the environment attribute is added to the search condition. FIG. 20 is an example of the screen on which the user terminal 200 accepts the input of the search condition in step S31. In the third embodiment, as indicated by a reference numeral 2001, a user interface for narrowing down by the environment attribute is provided. In the shown example, it is possible to narrow down by both the time zone and the weather.

In addition, in the third embodiment, in step S32, the server device 300 narrows down the in-vehicle video by the designated environment attribute. For example, in a case where the user designates “weather: rain”, the in-vehicle video captured during rainfall is extracted.

In the third embodiment, as described above, the environment attribute is added to the search condition, so that it is possible to search for a more appropriate in-vehicle video (for example, the in-vehicle video captured under the same environment as the environment in which the second user drives the vehicle).

Note that, in the present example, although the second user inputs the environment attribute as the search condition, the environment attribute used for the search does not always have to be input by the second user. For example, in a case where the second user is about to visit the designated point or section and the traveling environment at that time can be estimated, the in-vehicle video that matches the estimated traveling environment may be automatically extracted.

For example, in a case where an estimation is made that the second user is about to head to the designated point, a point in time (alternately, weather information at the point) at which the second user arrives at the point may be acquired to narrow down the in-vehicle video based on these pieces of information. As a result, for example, it is possible “to provide the in-vehicle video captured at night in a case where the second user passes through the designated point at night” or “to provide the in-vehicle video captured during snowfall in a case where it is snowing at the point designated by the second user”.

In addition, in the present example, although one environment attribute is associated with one in-vehicle video, a plurality of environment attributes may be associated with one in-vehicle video. For example, the environment attribute at any timing during traveling may be stored in the video database. With such a configuration, it is possible to search for an appropriate in-vehicle video even in a case where the environment is changed during traveling (for example, in a case where it starts to rain on the way).

### Modification Example

The embodiments described above are merely examples, and the present disclosure can be carried out with appropriate changes within a range not departing from the gist of the present disclosure.

For example, the processing or the means described in the present disclosure can be freely combined and carried out as long as no technical inconsistency occurs.

In addition, in the description of the embodiments, the terminal owned by the first user and the terminal owned by the second user are described as the same device, but the terminal used by the second user does not have to be the same device as the terminal used by the first user as long as the second user can access the video sharing service. For example, the second user may access the video sharing service by using a general-purpose computer. In addition, a navigation device or the like mounted on the vehicle may access the video sharing service and provide the video in the vehicle.

In addition, the additional information other than the information described as an example may be recorded in the drive recorder data and output during reproduction. For example, it is possible to overlay vehicle speed information on the in-vehicle video.

In addition, in the description of the embodiments, the server device 300 stores the video data, but the server device 300 may provide solely the function of the search without storing the video data. In this case, the server device 300 may store solely the information attached to the video, and use the information to search for the in-vehicle video. For example, instead of the video data, the server device 300 may store data indicating the location of the video data (network address, URL, or the like). In this case, the server device 300 may transmit a list including the location of the video data to the user terminal 200 as the search result.

In addition, in the description of the embodiments, the order of the search results is not described, but the search results may be output in order of priority by prioritizing the search results based on a predetermined rule. For example, the search results may be sorted in descending order of the capturing date and time. As a result, it is possible to provide fresher information to the second user. In addition, the capturing date and time may be added to the search condition.

In addition, the processing described as being executed by one device may be allocated and executed by a plurality of devices. Alternatively, the processing described as being executed by different devices may be executed by one device. In a computer system, the hardware configuration (server configuration) that realizes each function can be flexibly changed.

The present disclosure can also be realized by supplying a computer program that implements the functions described in the above embodiments to a computer, and reading out and executing the program by one or more processors provided in the computer. Such a computer program may be provided to the computer by a non-transitory computer-readable storage medium that can be connected to a system bus of the computer, or may be provided to the computer via a network. Examples of the non-transitory computer-readable storage medium include any type of disk, such as a magnetic disk (floppy (registered trademark) disk or hard disk drive (HDD)) or an optical disk (CD-ROM, DVD disk, or Blu-ray disk), a read-only memory (ROM), a random access memory (RAM), an EPROM, an EEPROM, a magnetic card, a flash memory, an optical card, and any type of medium suitable for storing an electronic instruction.

What is claimed is:

1. An information processing device comprising:
a storage unit configured to store video information that is information on a video captured by an in-vehicle camera and uploaded by a first user; and
a controller configured to execute
accepting designation of a point or a section from a second user, and
extracting a first video including the designated point or section from among a plurality of the uploaded videos.

2. The information processing device according to claim 1, wherein:
the video information includes route information of a vehicle that captures the video; and
the controller is configured to extract the first video based on the route information.

3. The information processing device according to claim 2, wherein the controller is configured to extract the first video including the designated point or section in a route.

4. The information processing device according to claim 1, wherein:
the video information includes information on an attribute of a vehicle that captures the video; and
the controller is configured to acquire designation related to the attribute of the vehicle from the second user to extract the first video based on the designation.

5. The information processing device according to claim 4, wherein the attribute of the vehicle is a size of the vehicle.

6. The information processing device according to claim 1, wherein:
the video information includes information on a traveling environment at a time of capturing the video; and
the controller is configured to acquire designation related to the traveling environment from the second user to extract the first video based on the designated traveling environment.

7. The information processing device according to claim 1, wherein:
the video information includes information on a traveling environment at a time of capturing the video; and
the controller is configured to extract the first video based on a traveling environment corresponding to the second user.

8. The information processing device according to claim 6, wherein the traveling environment includes at least one of weather or a traveling time zone.

9. The information processing device according to claim 7, wherein the traveling environment includes at least one of weather or a traveling time zone.

10. The information processing device according to claim 1, wherein:
the video information includes a network address of the video; and
the controller is configured to provide a network address corresponding to the first video to the second user.

11. An information processing method comprising:
a step of acquiring video information that is information on a video captured by an in-vehicle camera and uploaded by a first user;
a step of accepting designation of a point or a section from a second user; and
a step of extracting a first video including the designated point or section from among a plurality of the uploaded videos.

12. The information processing method according to claim 11, wherein:
the video information includes route information of a vehicle that captures the video; and
the first video is extracted based on the route information.

13. The information processing method according to claim 11, wherein:
the video information includes information on an attribute of a vehicle that captures the video; and
designation related to the attribute of the vehicle is acquired from the second user to extract the first video based on the designation.

14. The information processing method according to claim 13, wherein the attribute of the vehicle is a size of the vehicle.

15. The information processing method according to claim 11, wherein:
the video information includes information on a traveling environment at a time of capturing the video; and
designation related to the traveling environment is acquired from the second user to extract the first video based on the designated traveling environment.

16. The information processing method according to claim 11, wherein:
the video information includes information on a traveling environment at a time of capturing the video; and
the first video is extracted based on a traveling environment corresponding to the second user.

17. The information processing method according to claim 15, wherein the traveling environment includes at least one of weather or a traveling time zone.

18. The information processing method according to claim 16, wherein the traveling environment includes at least one of weather or a traveling time zone.

19. The information processing method according to claim 11, wherein:
the video information includes a network address of the video; and
a network address corresponding to the first video is provided to the second user.

20. A non-transitory storage medium storing a program causing a computer to execute:
a step of acquiring video information that is information on a video captured by an in-vehicle camera and uploaded by a first user;
a step of accepting designation of a point or a section from a second user; and
a step of extracting a first video including the designated point or section from among a plurality of the uploaded videos.
